(19) United States
(12) Patent Application Publication
(10) Pub. No.: US 2008/0077483 A1
(43) Pub. Date: Mar. 27, 2008

(54) Network system and method for accessing content and featuring advertising based on user criteria

(75) Inventors: Mark G. Hollo, Gulf Stream, FL (US); Brad J. Barton, Austin, TX (US)

Correspondence Address: R. MARTIN OLIVERAS, 18 BROOKLAKE ROAD, FLORHAM PARK, NJ, 07932, US

(73) Assignee: BR TRUST

(21) Appl. No.: 11/525,489

(22) Filed: Sep. 23, 2006

(51) Int. Cl. G06Q 30/00

(52) U.S. Cl. 705/14

(57) ABSTRACT

According to one embodiment of the present invention, in a system being capable of allowing access to desired content over a network, said system comprising: a server-computer; a source device being capable of providing a first desired content to said server-computer; a playing device being capable of receiving said first desired content from said server-computer and being capable of playing said first desired content; a director server-computer being capable of allowing said server-computer to provide said first desired content to said playing device; and an advertising server-computer being capable of receiving feedback information: from said server-computer, from said director server-computer, and from said playing device; and said advertising server-computer being capable of providing advertising information to said playing device in response to said feedback information.

### BACKGROUND OF THE INVENTION

1. Field of the Invention

This invention generally relates to a network system and method for accessing desired content and in particular to such a system and method which stores and utilizes user criteria for targeting specific advertisements to the user.

2. Description of the Prior Art

Krikorian et als patent application 2006009547; filed Jun. 7, 2005; published May 4, 2006; and entitled “Personal Media Broadcasting System”, generally discloses a system that enables video distribution over a computer network and allows a user to view and control media sources over a computer network from a remote location; a personal-broadcaster that receives an input from one or more types of media sources, digitizes and compresses the content, and streams the compressed media over a computer network to a media player running on any of a wide range of client devices for viewing the media. Such system may allow the user to issue control commands (e.g., “channel up”) from the media player to the broadcaster, causing the source device to execute the commands. The broadcaster and the media player may employ several techniques for buffering, transmitting, and viewing the content. Such patent application claims: “A personal media broadcasting system comprising: a personal media broadcaster having embedded hardware for receiving an analog signal from an audio/video source device, constructing a media stream from the signal, and transmitting the media stream over a computer network; and a media player client for communicating with the personal media broadcaster over the computer network to receive the media stream and playing the media stream for a user.” Such patent application further claims: “A personal media broadcaster comprising: an embedded input interface module for communication with one or more audio/video source devices; an embedded decoder module coupled to the input interface module for receiving an audio/video signal from the one or more audio/video source devices via the input interface module and for decoding the audio/visual signal; an embedded processing module coupled to the decoder module and configured to construct a media stream suitable for transmission over a computer network from the audio/visual signal; and an embedded network interface module for transmitting the media stream to a client over the computer network.” Such patent application still further claims: “A media player client application for a personal media broadcasting system, the media player client application comprising a computer-readable medium containing computer program code for performing a method comprising: receiving a media stream from a personal media broadcaster over a computer network, the media stream containing an encoded signal from an audio/video source device; playing the received media stream on a multi-purpose computing device; receiving a user command to control content in the media stream; and responsive to receiving the user command, communicating the user command to the personal media broadcaster to affect the content of the media stream.”

Krikorian et als patent application 20060095472; filed Jun. 7, 2005; published May 4, 2006; and entitled “Fast-Start Streaming And Buffering Of Streaming Content For Personal Media Player”, also generally discloses a system that enables video distribution over a computer network and allows a user to view and control media sources over a computer network from a remote location; a personal broadcaster that receives an input from one or more types of media sources, digitizes and compresses the content, and streams the compressed media over a computer network to a media player running on any of a wide range of client devices for viewing the media. Such system may allow the user to issue control commands (e.g., “channel up”) from the media player to the broadcaster, causing the source device to execute the commands. The broadcaster and the media player may employ several techniques for buffering, transmitting, and viewing the content. Such patent application claims: “A method for playing a media stream received over a network, the method comprising: receiving a media stream in real time from a personal media broadcaster; storing the media stream in a buffer; and playing the received media stream from the buffer at a decreased playback speed without waiting for the buffer to fill to a predetermined threshold, whereby the buffer fills at a rate slower than the media stream is received.” Such patent application further claims: “A method for playing a media stream received over a network, the method comprising: receiving a media stream from a personal media broadcaster; storing the media stream in a buffer; playing the media stream from the buffer; receiving a user command to control content in the media stream; and responsive to receiving the user command, entering a control mode in which the buffer is flushed and the received media stream is played.” Such patent application still further claims: “A computer program product for playing a media stream received over a network, the computer program product comprising a computer-readable medium containing computer program code for performing the method comprising: receiving a media stream from a personal media broadcaster; storing the media stream in a buffer; and playing the received media stream at a decreased playback speed and from the buffer without waiting for the buffer to fill to a predetermined threshold, whereby the buffer fills at a rate slower than the media stream is received.” Such patent application still further claims: “A computer program product for playing a media stream received over a network, the computer program product comprising a computer-readable medium containing computer program code for performing the method comprising: receiving a media stream from a personal media broadcaster; storing the media stream in a buffer; playing the media stream from the buffer; receiving a user command to control content in the media stream; and responsive to receiving the user command, entering a control mode in which the buffer is flushed and the received media stream is played.” Such patent application still further claims: “A method for playing a media stream received over a network, the method comprising: receiving a media stream in real time; storing the media stream in a buffer; and playing the received media stream from the buffer at a decreased playback speed without waiting for the buffer to fill to a predetermined threshold, whereby the buffer fills at a rate slower than the media stream is received.” Such patent application still further claims: “A method for playing a media stream received over a network, the method comprising: receiving a media stream; storing the media stream in a buffer; playing the media stream from the buffer; receiving a user command to control content in the media stream; and responsive to receiving the user command, entering a control mode in which the buffer is flushed and the received media stream is played.”

Krikorian et als patent application 20060095401; filed Jun. 7, 2005; published May 4, 2006; and entitled “Personal Media Broadcasting System With Output Buffer”, also generally discloses a system that enables video distribution over a computer network and allows a user to view and control media sources over a computer network from a remote location; a personal broadcaster that receives an input from one or more types of media sources, digitizes and compresses the content, and streams the compressed media over a computer network to a media player running on any of a wide range of client devices for viewing the media. Such system may allow the user to issue control commands (e.g., “channel up”) from the media player to the broadcaster, causing the source device to execute the commands. The broadcaster and the media player may employ several techniques for buffering, transmitting, and viewing the content. Such patent application claims: “A personal media broadcaster comprising: an input interface for communication with one or more audio/video source devices; a decoder coupled to the input interface for receiving an audio/video signal from the one or more audio/video source devices via the input interface and for decoding the audio/visual signal; a processor coupled to the decoder and configured to construct a media stream suitable for transmission over a network from the audio/visual signal; a buffer coupled to receive the media stream, the buffer coupled to the processor for communicating an amount of free space remaining in the buffer, wherein the processor constructs the media stream by encoding the audio/visual signal using a bit rate selected at least in part based on the amount of free space remaining in the buffer; and a network interface for transmitting the media stream stored in the buffer to a client over a network.” Such patent application further claims: “A personal media broadcasting system comprising: a personal media broadcaster having an input interface for communication with one or more audio/video source devices, the personal media broadcaster configured to construct a media stream suitable for transmission over a network from a signal received from one of the audio/video source devices, the media stream constructed by encoding the signal using a bit rate selected at least in part based on an amount of free space remaining in an intermediate output buffer, the personal media broadcaster further including a network interface for transmitting the media stream from the intermediate output buffer; and a client module for communicating with the personal media broadcaster over a network connection to receive the media stream, the client module configured to play the media stream for a user.” Such patent application still further claims: “A personal media broadcasting system comprising: a personal media broadcaster having an input interface for communication with one or more audio/video source devices, the personal media broadcaster configured to construct a media stream suitable for transmission over a network from a signal received from one of the audio/video source devices, the media stream constructed by encoding the signal using a bit rate selected at least in part based on an amount of free space remaining in an intermediate output buffer, the personal media broadcaster further including a network interface for transmitting the media stream from the intermediate output buffer; and a client module for communicating with the personal media broadcaster over a network connection to receive the media stream, the client module configured to play the media stream for a user.” Such patent application still further claims: “A personal media broadcasting system comprising: a personal media broadcaster having an input interface for communication with one or more audio/video source devices, the personal media broadcaster configured to construct a media stream suitable for transmission over a network from a signal received from one of the audio/video source devices, the media stream constructed by encoding the signal using a bit rate selected at least in part based on an amount of free space remaining in an intermediate output buffer, the personal media broadcaster further including a network interface for transmitting the media stream from the intermediate output buffer; and a client module for communicating with the personal media broadcaster over a network connection to receive the media stream, the client module configured to play the media stream for a user.” Such patent application still further claims: “A method for providing access to an audio/visual source at a location remote from the audio/visual source, the method comprising: receiving an input signal from an audio/visual source device; decoding the input signal; constructing a media stream suitable for transmission over a network by encoding the input signal using a bit rate selected at least in part based on an amount of free space remaining in a buffer; storing the media stream in the buffer; and sending the media stream from the buffer to a remote client over a network. Such patent application still further claims: “A method for providing access to an audio/visual source at a location remote from the audio/visual source, the method comprising: receiving an input signal from an audio/visual source device; decoding the input signal; constructing a media stream suitable for transmission over a network by encoding the input signal using a bit rate selected at least in part based on an amount of free space remaining in a buffer; storing the media stream in the buffer; and sending the media stream from the buffer to a remote client over a network.” Such patent application still further claims: “A method for providing access to a video source at a location remote from the video source, the method comprising: receiving a video signal; a step for creating a media stream from the video signal, the media stream encoded with a bit rate selected at least in part based on an amount of free space remaining in an output buffer; storing the encoded media stream in the output buffer; and sending the media stream from the output buffer to a remote client over a network.” Such patent application still further claims: “A method for streaming a media signal to a remote subscriber location, the method comprising: receiving a media signal for transmission to a subscriber location; constructing a media stream suitable for transmission over a transmission network by encoding the received media signal using a bit rate selected at least in part based on an amount of free space remaining in an output buffer; storing the media stream in the output buffer; and transmitting the media stream from the output buffer to the remote subscriber location over a transmission network.”

It is apparent from a reading of the above-cited prior art published patent applications that they do not disclose the “Network System And Method For Accessing Desired Content And Featuring Advertising Based On User Criteria” of the present invention.

3. Summary of the Invention

According to one embodiment of the present invention, in a system being capable of allowing access to desired content over a network, said system comprising: a server-computer; a source device being capable of providing a first desired content to said server-computer; a playing device being capable of receiving said first desired content from said server-computer and being capable of playing said first desired content; a director server-computer being capable of allowing said server-computer to provide said first desired content to said playing device; and an advertising server-computer being capable of receiving feedback information: from said server-computer: from said director server-computer: and from said playing device; and said advertising server-computer being capable of providing advertising information to said playing device in response to said feedback information.

### FEATURES OF THE PRESENT INVENTION

The intermediate Director Server notifies the intermediate Advertising Server of the connection, provides demographic data to the intermediate Advertising Server based on the user's profile data, and provides connection information relating to the proximal server-computer and the distal Playing device to the intermediate Advertising Server so that targeted advertisements can be sent to the distal Playing device by the intermediate Advertising Server based on the proximal Computer Server feedback, intermediate Director Server feedback, and distal Playing device feedback based on the user's demographic profile stored on the intermediate director-server.

The intermediate Director Server may block or inhibit the streaming of content that may have copyright issues from the server-computer to the distal playing device based on an administered database located on the intermediate Director Server. Also the intermediate Director Server may block or server.

The proximal receiver/transmitter is a networked or wireless three-part device. The proximal receiver/transmitter base is connected at the server-computer and facilitates the conversion of the VGA output at the server-computer to an analogue or digital television signal, porting of the television signal wirelessly to the proximal receiver/transmitter TV interface device located at the TV, and provides wireless keyboard and mouse functionality of the proximal server-computer through the proximal receiver/transmitter TV interface device. The proximal receiver/transmitter TV interface device receives the TV signal from the proximal receiver/transmitter base and connects to the TV either through the coaxial cable/antenna input or through the TV's composite inputs or through any other analogue or digital device inputs available on the TV. The proximal receiver/transmitter TV interface device also acts as a transmitter back to the proximal receiver/transmitter base to enable functionality of the proximal receiver/transmitter wireless keyboard and mouse. The proximal receiver/transmitter TV interface device has a built-in web cam that transmits back to the proximal receiver/transmitter base allowing capturing and streaming of the live video from the web cam through the CyberServer software located on the proximal server-Computer attached to the proximal receiver/transmitter base.

The aforementioned proximal receiver/transmitter TV interface device utilizes an integrated remote IR emitter cable to control any IR capable device located at the proximal TV location by allowing bi-directional transmission between the proximal receiver/transmitter's TV interface device and the proximal receiver/transmitter's base located at the proximal server-computer. The IR signal is controlled by the distal playing device that may be locally or remotely connected to the proximal server-computer.

Copyright protection is enabled by (1) encrypting the stream from the server-computer and decrypting the stream at the distal Playing device. (2) Since the System software is both at the server-computer and at he distal Playing device, any authorized individual with the System software installed on their distal PC or distal laptop may connect to any other authorized individual having the System software installed on their own remote PC or remote laptop. (a) The server-computer owner can set up individual access accounts for family members and select which devices and/or content are allowed for that access account. These access accounts are stored on the intermediate Director Server and accessed when logging in through the distal Playing device software from a local or remote location. (b) The System software has a built-in access account called the “Guest Pass” that allows any remote user to access ONLY the web cam feature of a server-computer. All other devices and content are blocked from a Guest Pass connection. The Guest Pass password is entered and changeable by the server-computer owner at any time. A server-computer owner can also block all Guest Pass connections or be notified upon a connection attempt and choose to allow the connection or terminate it as well as block all connections from user input specific addresses. (3) The System can terminate the account of anyone found to be in violation of the System's Terms of Use.

The user downloads and installs the system software.

The system software is a combination of: Windows Media Encoder which prepares the proximal or home audio/video content for streaming; and Windows Media Player which displays video from the stream on the distal or remote computer screen and plays audio through the speakers.

Once installed, the user creates an account on the intermediate Director Server. The intermediate Director Server is a data-center based Server that stores the playing device user's records, demographic data, and the location of the server-computer which is loaded with its own software and with further software residing on the Remote playing devices for facilitating the streaming of multimedia and/or television content.

Any computer running the system software may become a server-computer or a Playing device. Therefore, all software supported devices connected to the server-computer may be available for streaming while simultaneously playing a stream from a distal playing device.

Remote log-in is facilitated by logging in from the distal Playing device through the Director Server. Once a user is authenticated pursuant to his terms of enrollment for the system, then the director server directs the distal Playing device to the Server-Computer that the user wants to remotely connect to.

The director server notifies the Advertising Server of the connection, providing demographic data to the Advertising Server, and the connection information of the distal Playing device in order that targeted Advertisements or other content can be sent to that distal Player.

Once connected to the Server-Computer, the user can control which connected devices or content to stream from the Server-Computer to the user's distal Playing device.

Using the graphical user interface on the distal Playing device, the user can control devices and/or signals including but not limited to cable signals and boxes, antenna inputs and boxes, Tivo boxes and software, DVR and VCR recorders and Playing Devices, DVD Playing Devices and any device that can use an Infrared Red (“IR”) Remote control which is connected to the Server-Computer.

The Remote control functionality is facilitated by the Remote. The Remote is an IR emitter that may be connected to the Server-Computer by a USB interface cable. The software driver enables the user to input the server-computer connected devices' three digit Remote code into the distal Playing device's software thereby enabling the same control over a respective proximal device as its own Remote control functionality.

Each proximal device or media files contained in the content folder on the Server-Computer can be streamed to the distal Playing device remotely by selecting the source to view and/or listen to by user's selection on the distal Playing device's graphical user interface.

The entire time that the user is logged into the Server-Computer with the distal Playing device, the Advertising Server may feed rotating Advertisements to the distal Playing device which appear on the distal Playing device's graphical user interface.

A user can opt to receive a live stream from an advertiser and/or marketer with inter-activity through Instant Messaging.

The system can allow users to initiate live video streams bi-directionally between any two users which have the computer Server and Player software loaded onto their devices. This capability also applies to any pre-recorded content on any users' respective devices.

The Advertising Server logs user's information, including but not, limited to time connected, source device type being used, demographic profile data, and local channels being watched when the source connection is the proximal Tuner. Such proximal Tuner is a USB TV Tuner connected to the Server-Computer which is controlled through the distal Playing device's graphical user interface.

The system software is built around Microsoft's Windows Media and is a combination of two separate Windows Media components.

The Server-Computer software utilizes Windows Media's Windows Media Encoder 9 Series SDK or current version to capture A/V content from a variety of sources such as the Tuner, cable boxes, DVD Playing Devices, web cams, security cameras, or pre-recorded digital media files stored on the server-computer's hard drive.

Any type of multimedia device can be connected to the server-computer, the content captured, converted, and streamed by the Server-Computer software and remotely viewed through a LAN, the Internet, or any other network on a remote PC, remote laptop or remote portable device.

The distal Playing device's software utilizes Windows Media's Windows Media Player 9 Series SDK or any current version to locally or remotely view and hear the stream that is broadcast from the Server-Computer.

The Windows Media Device Manager 10 SDK or any current version provides the distal Playing device's compatibility with Windows Mobile powered portable devices.

The combination of the server-computer software and the distal Playing device software enables the a computer, laptop, or portable device source of media content and a Player of the local or remote media content. The Player component enables the Remote Internet, LAN or network connection to the Server component and access to the media devices and content stored on or connected to the Server-Computer device.

The Director Server is a data-center based Server array that maintains user/member records, including their demographic profile, the user/member's Server Internet access locations, and the Advertising Server gateway to the distal Playing devices.

The proximal Tuner is an external USB device that facilitates analogue or digital cable reception by the Server-Computer. The television channel is controlled by and viewed through a local or remote Player connection to the Server-Computer.

The Remote is a USB powered double-dongle IR emitter that allows the distal Player software to control a cable box or DVD Player just like using the device's Remote control. The device's three-digit IR code is used to program the distal Playing device's Remote control capability.

### OBJECTS OF THE PRESENT INVENTION

Allow a playing device user to remotely access and receive content from a proximal or home source.

Allow a playing device user to remotely receive and access content from a proximal or home source free of charge.

Allow an advertiser or marketer to receive real-time feedback demographic information or usage data relating to the playing device user.

Allow an advertiser or marketer to select, target and transmit specific Advertisements to a playing device user based on the feedback information.

Allow a playing device user to remotely access and receive content from a proximal or home source such as a video cassette recorder (VCR); digital video disc (DVD) player; television set or tuner; web-cam or live audio visual (A/V) content device; baby cam; or security camera content on hard drive.

Allow a playing device user to remotely access and receive content from a proximal or home source while utilizing a remote personal computer; cell phone; personal digital assistant; or remote laptop.

### ADVANTAGES OF THE PRESENT INVENTION

It is a plug and play solution that allows anyone, from anywhere in the world, at any time, to access the local television experience and much more of family, friends, business associates, etc.

It is offered FREE, with none of the associated hardware costs and monthly subscriptions of other devices.

It enables advertisers and marketers to broadcast and narrow-cast to target demographics with real time metrics for the total universe of users.

It enables users to remotely watch their home, friend's and office television and other devices through the Internet on a variety of displays including but not limited to laptops, desktop PCs, PDAs, cell phones and other Internet connected devices.

It allows users to surf through their own, as well as others, local channels from across the country or around the world at any time, record programs for viewing later, remotely control DVD playing devices, and access any music and/or videos stored on the home or base computer's hard drive.

It allows users using a web cam and microphone ported to the home computer based PC, to watch a LIVE, audio/video stream of family, friends, business associates, etc. with inter-activity via Instant Messaging.

It allows users using a web cam and microphone ported to the remote users PC, to stream back LIVE, audio/video content to family, friends, business associates, etc.

It offers optional devices for remote viewing such as security cameras facilitating integrated digital video security and surveillance features.

It allows cameras and/or recording devices to be automated to record continuously and/or capture events/experiences initiated through programmable motion detection and/or other event triggered features.

It allows additional devices such as a Tivo, VCR/DVD playing devices, and cable boxes to be connected and controlled using the remote.

It offers local, regional, national and international advertisers and marketers unique capabilities to broadcast and narrow-cast to specific demographics with real time metrics for the entire universe of viewers.

It also facilitates live, interactive advertising and marketing during a TV experience.

It facilitates a new, global media platform which is unique because for the first time the paradigm known as “space shifting” will be an interactive medium whereby one can provide advertisers, marketers, etc. with real time metrics including, but not limited to viewers demographic profile, time and length of content and advertising viewed, and viewer's Internet access location.

The embedded software according to the present invention incorporates unique, technical capabilities to address copyright protection and potential re-transmission issues.

The embedded software according to the present invention has design features (encryption) enforcing authentication which allows the System to allow and/or prohibit certain functions such as but not by way of limitation to copying or recording of prohibited or illegal content.

The embedded software according to the present invention facilitates 100% addressability and has integrated design features for digital rights management (DRM) issues.

The embedded software according to the present invention routes all authentication (including permission and authorized use and/or viewing/playing) through the Director Server.

Windows Media Encoder software and Windows Media Player software are within or controlled by the embedded software according to the present invention. By themselves the Windows Media Encoder software and the Windows Media Player software would not know what to encode or play. The embedded software according to the present invention tells the Windows Media Encoder software what to encode and stream and tells the Windows Media Player software what to play. Through the graphic user interface a user may select a source device to view by clicking on an icon or menu item. This action by the user causes the embedded software according to the present invention to engage the Windows Media Encoder software to select the correct software driver for capturing the output of that device, encode it, and stream it to the specific local or remote player that requested the stream. Also, the embedded software according to the present invention tells the Windows Media Encoder software when to select previously encoded audio, video or A/V files, that are already stored on the hard drive of the Server-Computer, to be streamed to the specific local or remote player that requested the stream. Once the streaming commences on the Server-Computer, the embedded software according to the present invention tells the Windows Media Player software to play that stream within the graphical user interface on the Player Computer. All devices that download the embedded software according to the present invention are capable of both above functions simultaneously, i.e. essentially wearing two hats at the same time as a provider of desired media content and as a player of desired media content.

The server-computer and player embedded software according to the present invention interfaces with a database of programming in respective markets residing on the Director Server and cross references it with permitted remote user geographic locations.

It facilitates the unique capability in the space shifting sector to sell and/or place advertising by broadcasting and/or narrow-casting to target specific demographics in local, regional, national and international markets.

It facilitates the unique capability in the space shifting sector to provide and/or sell real time metrics for re-streamed or re-transmitted copyrighted content to 100% of the users/viewers.

It provides real time metrics and addressability for 100% of users/viewers

It allows anyone with a broadband Internet connection to experience live and pre-recorded streams from their home television as well as other connected devices such as a DVR/VCR, Tivo, DVD player, etc.

It comprises an interactive network architecture to facilitate addressability, advertising, and the sale of metrics

It utilizes the above-mentioned functionalities to create profitable revenue streams derived from the ability to practice user authentication, advertising/marketing addressability facilitating broadcasting and narrow-casting to targeted demographics and real time, 100% accurate metrics for the total universe of users/viewers.

### BRIEF DESCRIPTION OF THE DRAWINGS

The above and other objects, advantages and features of the present invention will be further appreciated from a reading of the following detailed description in conjunction with the drawing in which:

FIG. 1 shows system 10 connected to the internet and shows various proximal devices and distal devices according to the present invention.

FIG. 2 shows system 10 connected to the internet and shows various proximal devices according to the present invention.

FIG. 3 further shows system 10 according to the present invention.

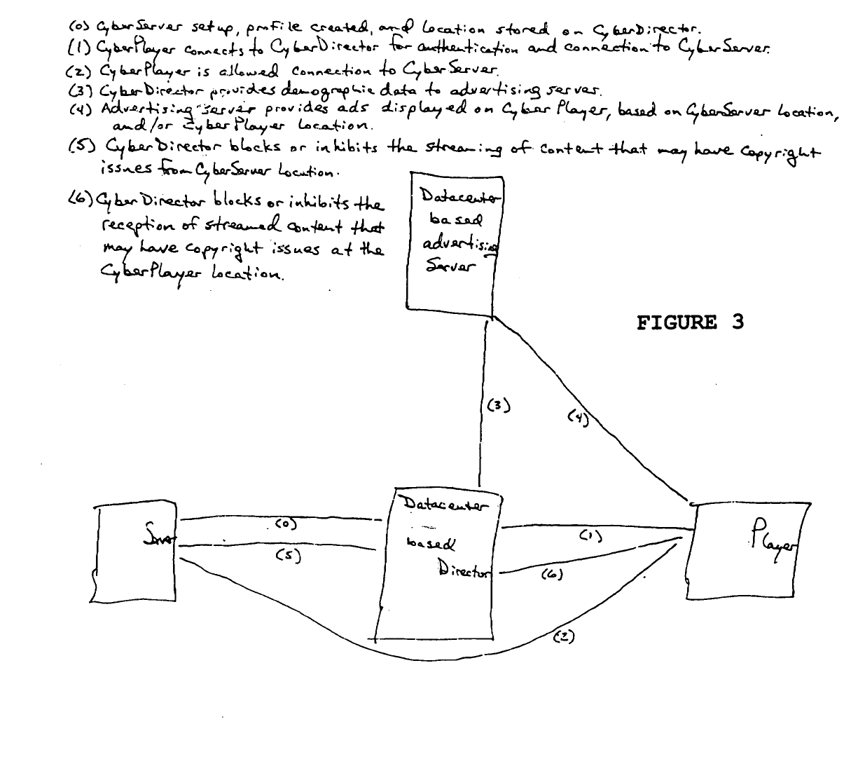

FIG. 4 shows the tuning device of system 10 according to the present invention.

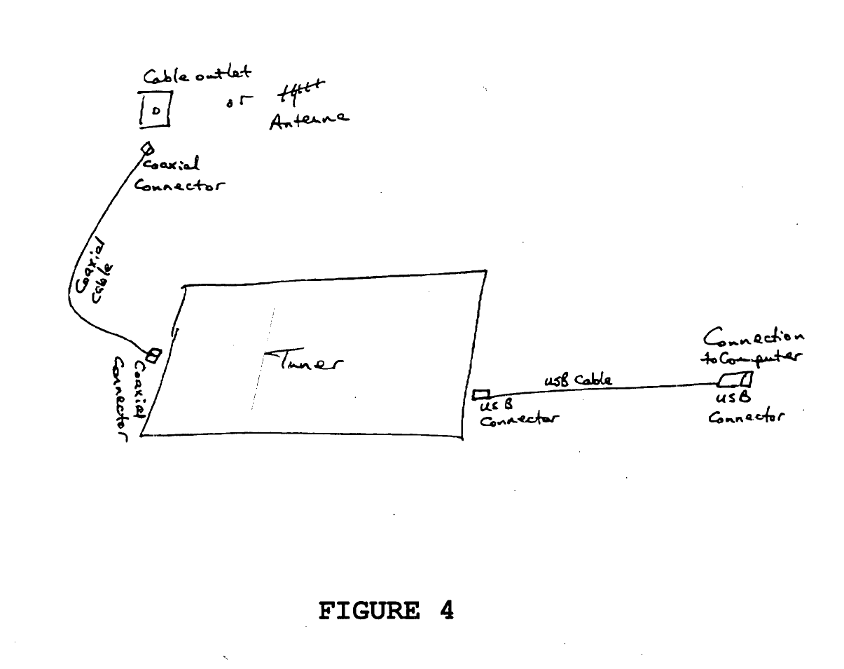

FIG. 5 shows the remote device of system 10 according to the present invention.

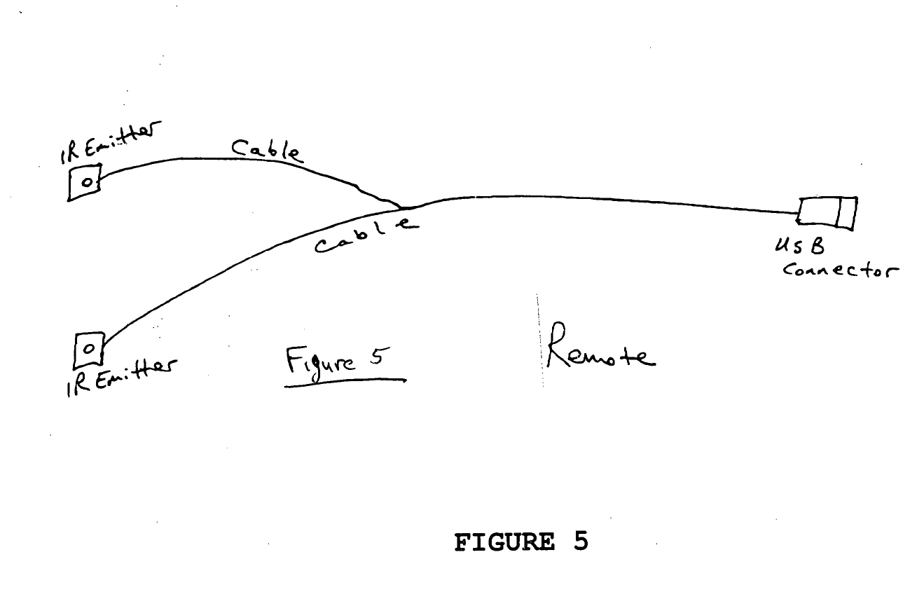

FIG. 6 shows the transmitter/receiver device of system 10 according to the present invention.

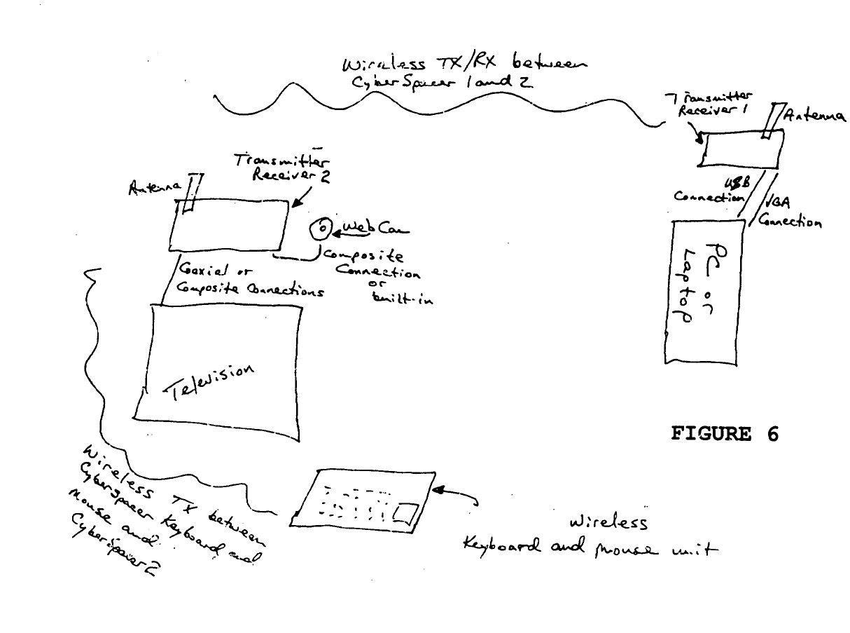

### DETAILED DESCRIPTION OF THE INVENTION

According to the present invention, the term “computer” includes but is not limited to: a general computer; a general server; a network computer; a network server, a micro-processor; a server-computer; a device that is capable of: receiving data, storing data, processing data, and transmitting data; a programmed device with stored algorithms for receiving data or commands, for processing data or commands, and for transmitting data or commands; or any combination of the aforementioned.

According to the present invention, the terms “proximal”, “intermediate” and “distal” are used solely to facilitate the reading of the following textual description in conjunction with the drawings. In no case is the use of such terms to be construed to limit the actual physical location or the actual transmitting connections among the media source devices, the playing devices, and the server-computers according to the present invention. Such media source devices, playing devices, and server-computers may physically be located anywhere as long as they are connected via a suitable network. Also the following textual description showing examples of uni-directional desired media content access are for explanatory purposes only. According to the present invention the accessing of desired media content from a source device and the providing of such desired media content to the playing device may be done bi-directionally among all the server-playing devices comprising the embedded software according to the present invention.

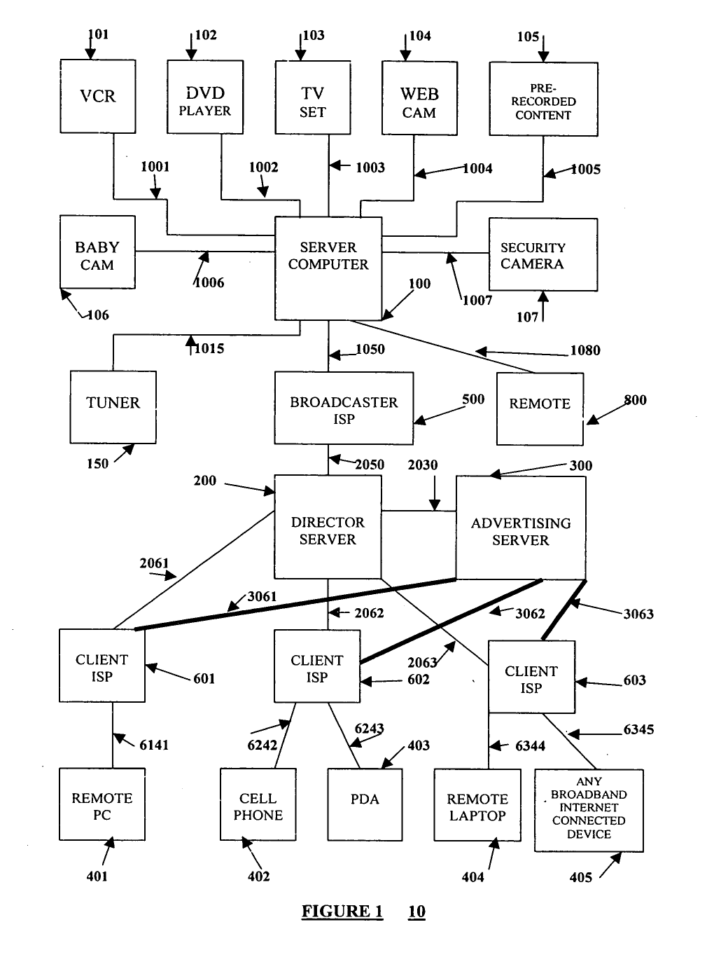

### FIG. 1

FIG. 1 shows system 10 connected to the internet and shows various proximal and distal devices according to the present invention. In FIG. 1, System 10 comprises: programmable proximal or home-based personal server-computer 100; USB enabled TV tuner and capture device 150; intermediate director server-computer 200; and intermediate advertising server-computer 300. Associated with server-computer 100 may be the following proximal devices: video cassette recorder (VCR) 101; digital video disc (DVD) player 102; television set or monitor 103; web-cam or live audio visual (A/V) content device 104; pre-recorded video clips, movies, and audio recordings or music files 105 being stored on the hard-drive of server-computer 100; baby cam 106; security camera 107; and remote device 800. The function of tuner 150 includes the tuning in of television channels. Also associated with system 10 is the proximal or broadcaster internet service provider facility 500. Also associated with system 10 may be: distal or client internet service provider facility 601 serving distal or remote personal computer 401; distal or client internet service provider facility 602 serving cell phone 402 and personal digital assistant 403; and distal or client internet service provider facility 603 serving distal or remote laptop 404 and distal broadband device 405.

Transmitting means 1001 may allow server-computer 100 and VCR 101 to send signals to each other and to receive signals from each other. Transmitting means 1002 may allow server-computer 100 and DVD player 102 to send signals to each other and to receive signals from each other. Transmitting means 1003 may allow server-computer 100 and TV set 103 to send signals to each other and to receive signals from each other. Transmitting means 1004 may allow server-computer 100 and web cam 104 to send signals to each other and to receive signals from each other. Transmitting means 1005 may allow server-computer 100 to internally access pre-recorded content 105 being located on its hard-drive. Transmitting means 1006 may allow server-computer 100 and baby cam 106 to send signals to each other and to receive signals from each other. Transmitting means 1007 may allow server-computer 100 and security camera 107 to send signals to each other and to receive signals from each other. Transmitting means 1015 may allow server-computer 100 and tuner 150 to send signals to each other and to receive signals from each other. Transmitting means 1080 may allow server-computer 100 and remote device 800 to send signals to each other and to receive signals from each other. Transmitting means 1050 may allow server-computer 100 and broadcaster ISP 500 to send signals to each other and to receive signals from each other. The aforementioned transmitting means may connect to server-computer 100 by way of a USB terminal. The aforementioned transmitting means may be wired, wireless or a combination of wired and wireless.

Transmitting means 2050 may allow intermediate director server-computer 200 and broadcaster ISP 500 to send signals to each other and to receive signals from each other. Transmitting means 2030 may allow intermediate director server-computer 200 and intermediate advertising server-computer 300 to send signals to each other and to receive signals from each other. Transmitting means 2061 may allow intermediate director server-computer 200 and client ISP 601 to send signals to each other and to receive signals from each other. Transmitting means 2062 may allow intermediate director server-computer 200 and client ISP 602 to send signals to each other and to receive signals from each other. Transmitting means 2063 may allow intermediate director server-computer 200 and client ISP 603 to send signals to each other and to receive signals from each other. Transmitting means 3061 may allow intermediate advertising server-computer 300 and client ISP 601 to send signals to each other and to receive signals from each other. Transmitting means 3062 may allow intermediate advertising server-computer 300 and client ISP 602 to send signals to each other and to receive signals from each other. Transmitting means 3063 may allow intermediate advertising server-computer 300 and client ISP 603 to send signals to each other and to receive signals from each other. The aforementioned transmitting means may be wired, wireless or a combination of wired and wireless.

Transmitting means 6141 may allow client ISP 601 and remote PC 401 to send signals to each other and to receive signals from each other. Transmitting means 6242 may allow client ISP 602 and cell phone 402 to send signals to each other and to receive signals from each other. Transmitting means 6243 may allow client ISP 602 and PDA 403 to send signals to each other and to receive signals from each other. Transmitting means 6344 may allow client ISP 603 and remote laptop 404 to send signals to each other and to receive signals from each other. Transmitting means 6345 may allow client ISP 603 and broadband internet connected device 405 to send signals to each other and to receive signals from each other. The aforementioned transmitting means may be wired, wireless or a combination of wired and wireless.

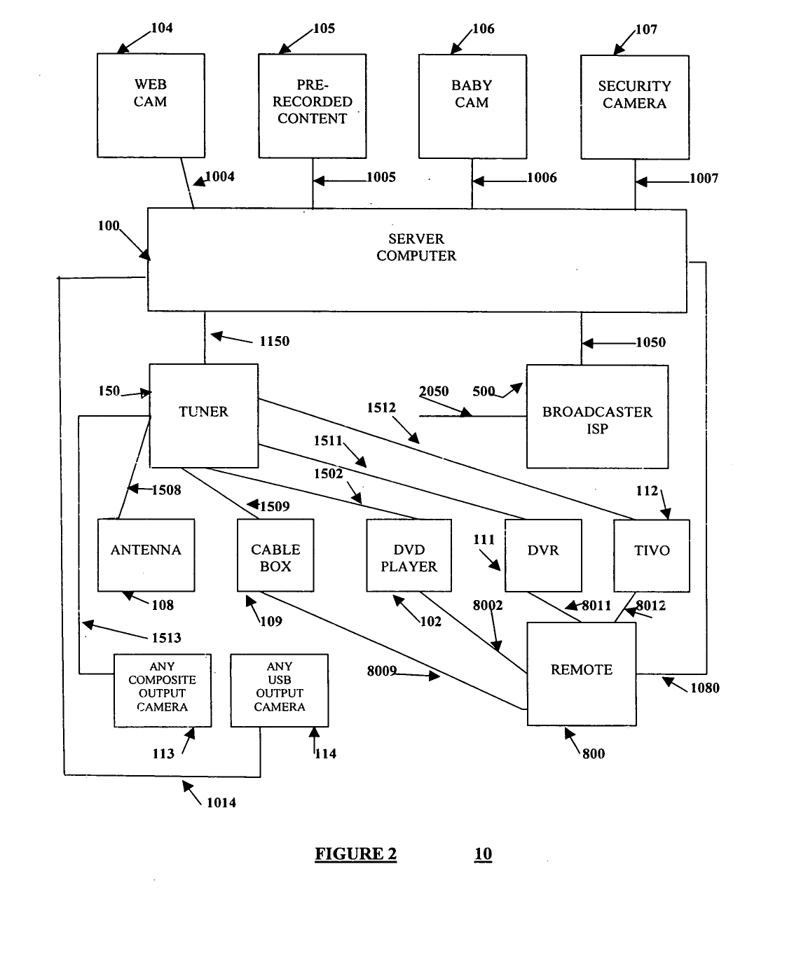

### FIG. 2

FIG. 2 shows system 10 and various proximal devices according to the present invention. In FIG. 2, System 10 comprises: programmable proximal or home-based personal server-computer 100; USB enabled TV tuner and capture device 150; and remote device 800. Associated with server-computer 100 may be the following proximal devices: digital video disc (DVD) player 102; web-cam or live audio visual (A/V) content device 104; pre-recorded video clips, movies, and audio recordings and music files 105 being stored on the hard-drive of server-computer 100; baby cam 106; security camera 107; antenna 108; cable box 109; digital video recorder (DVR) 111; and TIVO device 112. The function of tuner 150 includes the tuning in of outputs from antenna 108, cable box 109, DVD player 102, DVR device 111, TIVO device 112, composite output camera device 113, and USB output camera device 114. Also associated with system 10 is the proximal or broadcaster internet service provider facility 500.

Transmitting means 1004 may allow server-computer 100 and web cam 104 to send signals to each other and to receive signals from each other. Transmitting means 1005 may allow server-computer 100 to internally access pre-recorded content 105 being located on its hard-drive. Transmitting means 1006 may allow server-computer 100 and baby cam 106 to send signals to each other and to receive signals from each other. Transmitting means 1007 may allow server-computer 100 and security camera 107 to send signals to each other and to receive signals from each other. Transmitting means 1150 may allow server-computer 100 and tuner 150 to send signals to each other and to receive signals from each other. Transmitting means 1080 may allow server-computer 100 and remote device 800 to send signals to each other and to receive signals from each other. Transmitting means 1050 may allow server-computer 100 and broadcaster ISP 500 to send signals to each other and to receive signals from each other. Transmitting means 2050 may allow proximal broadcaster ISP 500 and intermediate director server-computer 200 of FIG. 2 to send signals to each other and to receive signals from each other. Aforementioned transmitting means 1004, 1005, 1006, 1007, 1150, 1050 and 1080 may connect to server-computer 100 by way of USB terminals. The aforementioned transmitting means may be wired, wireless or a combination of wired and wireless.

Transmitting means 1502 may allow tuner device 150 and DVD player 102 to send signals to each other and to receive signals from each other. Transmitting means 1508 may allow tuner device 150 and antenna 108 to send signals to each other and to receive signals from each other. Transmitting means 1509 may allow tuner device 150 and cable box 109 to send signals to each other and to receive signals from each other. Transmitting means 1511 may allow tuner device 150 and DVR device 111 to send signals to each other and to receive signals from each other. Transmitting means 1512 may allow tuner device 150 and TIVO device 112 to send signals to each other and to receive signals from each other. The aforementioned transmitting means may be wired, wireless or a combination of wired and wireless.

Transmitting means 8002 may allow remote device 800 and DVD player 102 to send signals to each other and to receive signals from each other. Transmitting means 8009 may allow remote device 800 and cable box 109 to send signals to each other and to receive signals from each other. Transmitting means 8011 may allow remote device 800 and DVR device 111 to send signals to each other and to receive signals from each other. Transmitting means 8012 may allow remote device 800 and TIVO device 112 to send signals to each other and to receive signals from each other. Transmitting means 1513 may allow tuner device 150 and composite output camera device 113 to send signals to each other and to receive signals from each other. Transmitting means 1014 may allow server-computer 100 and USB output camera device 114 to send signals to each other and to receive signals from each other. The aforementioned transmitting means may be wired, wireless or a combination of wired and wireless.

Intermediate advertising server-computer 300 rotates selected Advertisements and transmits them to distal playing devices 401-404 when the playing device user connects to his proximal personal broadcaster device such as server-computer 100. Intermediate advertising server-computer 300 receives and utilizes demographic data relating to the playing device user's profile to select the Advertisements that are to be targeted to such playing device user. Intermediate advertising server-computer 300 also receives and stores information relating to the user's time of viewing, length of viewing, sources of viewing and other information relating to the playing device user's habits and preferences.

The first step of Personal broadcasting is to connect proximal TV tuner and proximal capture device 150 to the USB port of proximal computer 100 and to connect any other A/V devices to proximal device 150 or to other USB ports of proximal computer 100.

The next step is to download and install system software according to the present invention onto proximal computer 100 and onto the distal devices such as remote PC 401; cell phone 402; PDA 403; and remote laptop 404.

The final step is to remotely connect to server-computer 100 via the internet by starting the system software according to the present invention and by entering the playing device user's personal password onto the distal Playing device. This authentication is effected by intermediate director server-computer 200.

The following are general definitions of the devices mentioned herein:

VideoCassette Recorder: VCR: A videotape recording and playback machine that houses both supply and take-up reels of tape in a convenient removable package. The most ubiquitous VCR format is the ½″ VHS tape, which has been widely used for entertainment and training. One inch videocassettes are used for mastering video recordings, and Sony's ¾″ Umatic videocassettes were widely used in corporate training before VHS tapes became popular.

Digital Video Disc or Digital Versatile Disc: DVD: An optical digital disc for storing movies and data. Introduced in the U.S. in 1997, and developed by both the computer and movie industries, the disc uses the same diameter platter as a CD (120 mm/4.75″ diameter), but holds 4.7 GB rather than 700 MB. Whereas CDs use only one side, DVD's can be recorded on both sides as well as in dual layers. DVD drives/playing devices read most CD media as well.

Standard Definition Movie DVD's: DVD-Video is the movie format, which uses MPEG-2 compression to provide approximately two hours of video per side at standard definition TV resolution (480i resolution). When most people mention the word “DVD,” they are referring to a DVD-Video disc.

High Definition Movie DVD's: Blu-ray and HD DVD are two competing formats that have enough storage for two hour high-definition movies (1080i resolution).

Read Only DVD's: A DVD-ROM is like a larger CD-ROM that holds data and interactive audio and video material.

Writeable/Recordable DVD's: A DVD-RAM is a rewriteable DVD that functions like a removable hard disk. DVD-RAM media can be rewritten 100,000 times before it is no longer usable. DVD−R and DVD+R are competing write-once formats for movies or data. DVD−RW and DVD+RW are competing, rewriteable (re-recordable) formats that unlike DVD-RAM's 100,000 cycles, can only be rewritten 1,000 times. Aimed at the consumer, 1,000 rewrites is considered more than sufficient.

Music DVD's: DVD-Audio is a second-generation digital music format that provides higher sampling rates than audio CDs. Many have welcomed the new format, believing that the original audio CD was unable to capture the total sound spectrum.

Originally, “Digital Video Disc.” Since the technology became important to the computer world, the “video” was dropped, and it was just D-V-D. Later, it was dubbed “Digital Versatile Disc” by the DVD Forum.

WEB CAMera: A video camera that is used to send periodic images or continuous frames to a Web site for display. Webcam software typically captures the images as JPEG or MPEG files and uploads them to the Web server. There are countless Webcam sites on the Internet that have cameras pointed at virtually everything. They provide videos of people going about their daily work as well as offering the online equivalent of the live “peep show.”

Audio/Video or Audio/Visual: A/V: Refers to equipment and applications that deal with sound and sight. The A/V world includes microphones, audio tape recorders, audio mixers, sound systems, analog and digital still and video cameras, film projectors, slide projectors, VCRs, CD playing devices/recorders and DVD playing devices/recorders. The term was originally “audio/visual.”

Baby Cam: Generally refers to a web camera including bi-directional audio reception and transmission for monitoring an infant.

### General Features of System 10

The user downloads and installs the system software according to the present invention.

The system software according to the present invention may comprises a combination of:
(A) Windows Media Encoder which prepares the audio/video content for streaming and is downloaded onto the home or proximal computer and distal playing devices 401-404; and
(B) Windows Media Player which displays video from the received stream on the distal device screen and plays audio through the speakers and is downloaded onto distal devices 401-404 and proximal server-computer 100.

Once the software (A) (B) above is downloaded or installed, the playing device user creates an account on Intermediate Director Server-Computer 200. Intermediate Director Server-Computer 200 is a data-center based Server that stores the playing device user's records, demographic data, and the location of the playing device user's client ISP Server 601-603 with software (A) (B) above residing on Remote PC 401, laptop 404, cell phone 402, PDA 403 for facilitating the streaming of the received multimedia and/or television content.

Any computer running the system software according to the present invention becomes a Server-Computer such as computer 100 and any distal Player 401-404. Therefore, all supported proximal and distal devices connected to server-computer 100 are available for streaming.

Remote log-in is facilitated by logging in from distal Playing Devices 401-404 through Intermediate Director Server-Computer 200. Once a playing device user is authenticated pursuant to his terms of enrollment for the system, then Intermediate Director Server-Computer 200 directs distal Playing Devices 401-404 to Server-Computer 100 which the playing device user wants to remotely connect to.

Intermediate Director Server-Computer 200 notifies Intermediate Advertising Server-Computer 300 of such connection and provides demographic data to Intermediate Advertising Server-Computer 300 plus the connection information of distal Playing devices 401-404 so that that targeted Advertisements or other content can be sent to distal Playing devices 401-404 by Intermediate Advertising Server-Computer 300.

Once connected to Server-Computer 100, the playing device user can control which devices or content to stream from Server-Computer 100 to the distal Playing device such as remote personal computer 401; cell phone 402; digital assistant 403; and remote laptop 404.

Using the graphical user interface on the distal Playing device such as remote personal computer 401; cell phone 402; digital assistant 403; and remote laptop 404, the playing device user can control proximal devices and/or signals including but not limited to cable signals and boxes, antenna inputs and boxes, Tivo boxes and software, DVR and VCR recorders and playing devices, DVD playing devices and any device that can use an Infrared Red (“IR”) Remote control which is connected to Server-Computer 100.

Remote control functionality is facilitated by Remote device 800. Remote device 800 may be an IR emitter device that may be connected to Server-Computer 100 by a USB interface cable. The software driver enables the user to input the Remote device's three digit Remote code onto the distal Playing device software according to the present invention thereby enabling the remote control over a respective source device as its own Remote control functionality.

Each device or content folder on Server-Computer 100 may be streamed to distal Playing devices 401-404 remotely by selecting the source to view and/or listen to by Playing device user's selection on the DISTAL Playing device's graphical user interface.

The entire time that the playing device user is logged into Server-Computer 100 with distal Playing devices 401-404, Intermediate Advertising Server-Computer 300 can feed rotating Advertisements to distal Playing devices 401, 402, 403 or 404; which advertisements then appear on such distal Playing devices' graphical user interface.

A user can opt to receive a live stream from an advertiser and/or marketer with inter-activity through Instant Messaging.

System 10 allows users to initiate live video streams bi-directionally between any two users which have the Server-Computer and Playing device softwares downloaded onto such respective devices according to the present invention. This capability also applies to any pre-recorded content on any users' respective devices.

Intermediate Advertising Server-Computer 300 logs the playing device user's information including but not limited to time connected, source device type being used, demographic profile data, and local channels being watched when the source connection is proximal Tuner 150. Proximal Tuner device 150 may be a USB TV Tuner connected to Server-Computer 100 which is controlled through the distal Playing device's graphical user interface.

Part of System 10 software may be built around Microsoft's Windows Media and may be a combination of two separate Windows Media components.

The Server-Computer software may utilize Windows Media's Windows Media Encoder 9 Series SDK to capture A/V content from a variety of sources such as proximal Tuner device 150, cable box 109, DVD Player 102, web cam 104, security cameras 107, or pre-recorded digital media files 105 stored on the hard drive of server-computer 100.

Any type of multi-media device can be connected to server-computer 100. The content of such device is then captured, converted, and streamed by Server-Computer software and remotely viewed through a LAN or the Internet on remote personal computer 401; cell phone 402; digital assistant 403; or remote laptop 404.

The distal Playing device software in part utilizes Windows Media's Windows Media Player 9 Series SDK to locally or remotely view and hear the stream that is broadcast from Server-Computer 100.

The Windows Media Device Manager 10 SDK provides the distal Playing device's compatibility with Windows Mobile powered portable devices.

The combination of the server-computer software and the distal Playing device software enables server-computer 100 to be both a source of media content and a Player of local or Remote media content. The distal Playing device enables Remote Internet connection to Server-Computer 100 and access to the media devices and content stored on or connected to Server-Computer 100.

Intermediate Director Server-Computer 200 is a data-center based Server array that maintains user/member records, including their demographic profile, the user/member's distal Server Internet access locations, and Intermediate Advertising Server-Computer 300 gateway to the distal Playing Devices.

Proximal Tuner device 150 is an external USB device that facilitates analogue or digital cable reception by Server-Computer 100. The television channel is controlled by and viewed through a local or Remote Playing device connection to Server-Computer 100.

Proximal Remote device 800 may be a USB powered double-dongle IR emitter that allows the distal Playing device software to control a cable box or DVD Playing device 102 just like using the distal Playing device's Remote control function. The proximal remote device's three-digit IR code may be used to program the distal Playing device's Remote control capability.

### Specific Features of System 10

System 10 allows access to desired content over a network. System 10 comprises: server-computer 100; source devices 101-107 for providing a first desired content to server-computer 100; playing devices 401-404 for receiving said first desired content from server-computer 100 and for playing said first desired content; director server-computer 200 for allowing server-computer 100 to provide said first desired content to playing devices 401-404; advertising server-computer 300 for receiving feedback information from server-computer 100, from director server-computer 200, and from playing devices 401-404; and advertising server-computer 300 also for providing advertising information to playing devices 401-404 in response to said feedback information.

In system 10, advertising server-computer 300 also provides advertising information to server-computer 100 in response to said feedback information.

System 10 comprises: first server-playing device 100; source devices 101-107 for providing a first desired content to first server-playing devices 100; second server-playing devices 401-404 for receiving said first desired content from first server-playing devices 100 and for playing said first desired content; director server-computer 200 for allowing said first server-playing device 100 to provide said first desired content to said second server-playing devices 401-404; and advertising server-computer 300 for receiving feedback information from first server-playing device 100, from director server-computer 200, and from second server-playing devices 401-404; advertising server-computer 300 also provides advertising information to first server-playing devices 100 and second server-playing devices 401-404 in response to said feedback information.

In system 10, director server-computer 200 comprises a database of authorized playing device users and of authorized content and allows said authorized playing devices users to access said authorized content.

In system 10, director server-computer 200 comprises a database of authorized server-computer users and of authorized content and allows said authorized server-computer users to access said authorized content.

In system 10, director server-computer 200 comprises a database of un-authorized playing device users and of authorized content and blocks said un-authorized playing device users from accessing said authorized content.

In system 10, director server-computer 200 comprises a database of un-authorized server-computer users and of authorized content and blocks said un-authorized server-computer users from accessing said authorized content.

In system 10, director server-computer 200 comprises a database of authorized server-computer users and of un-authorized content and blocks said authorized server-computer users from accessing said un-authorized content.

In system 10, director server-computer 200 comprises a database of authorized playing device users and of un-authorized content and blocks said authorized playing device users from accessing said un-authorized content.

In system 10, director server-computer 200 comprises a database of authorized server-computer users and of un-authorized content and blocks said authorized server-computer users from accessing said un-authorized content.

In system 10, director server-computer 200 comprises a database of un-authorized playing device users and of un-authorized content and blocks said un-authorized playing device users from accessing said un-authorized content.

In system 10, director server-computer 200 comprises a database of un-authorized server-computer users and of un-authorized content and blocks said un-authorized server-computer users from accessing said un-authorized content.

In system 10, said network may be the Internet.

In system 10, server-computer 100 comprises embedded software and Media Encoder software; said embedded software causes said Media Encoder software to select the correct software driver for capturing said first desired content from its respective source devices 101-107; said embedded software causes said Media Encoder software to encode said first desired content; and said embedded software causes said Media Encoder software to stream said first desired content to playing devices 401-404.

In system 10, server-computer 100 comprises embedded software and Media Encoder software; said embedded software causes said Media Encoder software to select previously encoded first desired content already stored on server-computer 100; and said embedded software causes said Media Encoder software to stream said first desired content to playing devices 401-404.

In system 10, playing devices 401-404 comprise embedded software and Media Encoder software; said embedded software causes said Media Encoder software to select the correct software driver for capturing a second desired content from playing devices 401-404; said embedded software causes said Media Encoder software to encode said second desired content; and said embedded software causes said Media Encoder software to stream said second desired content to server-computer 100.

In system 10, playing devices 401-404 comprise embedded software and Media Encoder software; said embedded software causes said Media Encoder software to select previously encoded second desired content already stored on playing devices 401-404; and said embedded software causes said Media Encoder software to stream said second desired content to server-computer 100.

In system 10, server-computer 100 comprises embedded software and Media Player software; said embedded software causes said Media Player software to play received second desired content.

In system 10, playing devices 401-404 comprise embedded software and Media Player software; said embedded software causes said Media Player software to play said received first desired content.

In system 10, server-computer 100 comprises first embedded software and first Media Encoder software; said first embedded software causes said first Media Encoder software to select the correct software driver for capturing said first desired content from respective source devices 101-107; said first embedded software causes said first Media Encoder software to encode said first desired content; and said first embedded software causes said first Media Encoder software to stream said first desired content to playing devices 401-404; playing devices 401-404 comprise second embedded software and second Media Encoder software; said second embedded software causes said second Media Encoder software to select the correct software driver for capturing a second desired content from playing devices 401-404; said second embedded software causes said second Media Encoder software to encode said second desired content; and said second embedded software causes said second Media Encoder software to stream said second desired content to server-computer 100.

In system 10, server-computer 100 comprises first embedded software and first Media Player software; said first embedded software causes said first Media Player software to play received second desired content; playing devices 401-404 comprise second embedded software and second Media Player software; said second embedded software causes said second Media Player software to play said received first desired content.

In system 10, server-computer 100 comprises first embedded software and first Media Encoder software; said first embedded software causes said first Media Encoder software to select previously encoded first desired content already stored on server-computer 100; and said first embedded software causes first said Media Encoder software to stream said first desired content to playing devices 401-404; playing devices 401-404 comprise second embedded software and second Media Encoder software; said second embedded software causes said second Media Encoder software to select previously encoded second desired content already stored on playing devices 401-404; and said second embedded software causes said second Media Encoder software to stream said second desired content to server-computer 100.

In system 10, server-computer 100 is a first server-playing device and comprises embedded software and Media Encoder software; said embedded software causes said Media Encoder software to select the correct software driver for capturing said first desired content from source devices 101-107; said embedded software causes said Media Encoder software to encode said first desired content; and said embedded software causes said Media Encoder software to stream said first desired content to playing devices 401-404 being second server-playing devices.

In system 10, server-computer 100 is a first server-playing devices and comprises embedded software and Media Encoder software; said embedded software causes said Media Encoder software to select previously encoded first desired content already stored on said first server-playing device; and said embedded software causes said Media Encoder software to stream said first desired content to playing devices 401-404 being second server-playing devices.

In system 10, playing devices 401-404 are a second server-playing devices and comprises embedded software and Media Encoder software; said embedded software causes said Media Encoder software to select the correct software driver for capturing a second desired content from said second server-playing devices 401-404; said embedded software causes said Media Encoder software to encode said second desired content; and said embedded software causes said Media Encoder software to stream said second desired content to server-computer 100 being a first server-playing device.

In system 10, playing devices 401-404 are a second server-playing devices and comprise embedded software and Media Encoder software; said embedded software causes said Media Encoder software to select previously encoded second desired content already stored on said second server-playing devices 401-404; and said embedded software causes said Media Encoder software to stream said second desired content to server-computer 100 being a first server-playing device.

In system 10, server-computer 100 is a first server-playing device and comprises embedded software and Media Player software; said embedded software causes said Media Player software to play a received second desired content.

In system 10, playing devices 401-404 are second server-playing devices and comprise embedded software and Media Player software; said embedded software causes said Media Player software to play said received first desired content.

In system 10, server-computer 100 is a first server-playing device and comprises first embedded software and first Media Encoder software; said first embedded software causes said first Media Encoder software to select the correct software driver for capturing said first desired content from respective source devices 101-107; said first embedded software causes said first Media Encoder software to encode said first desired content; and said first embedded software causes said first Media Encoder software to stream said first desired content to playing devices 401-404 being second server-playing devices; said second server-playing devices 401-404 comprising second embedded software and second Media Encoder software; said second embedded software causes said second Media Encoder software to select the correct software driver for capturing a second desired content from said second server-playing devices 401-404; said second embedded software causes said second Media Encoder software to encode said second desired content; and said second embedded software causes said second Media Encoder software to stream said second desired content to said first server-playing device 100.

In system 10, server-computer 100 is a first server-playing device and comprises first embedded software and first Media Player software; said first embedded software causes said first Media Player software to play a received second desired content; playing devices 401-404 being second server-playing devices and comprise second embedded software and second Media Player software; said second embedded software causes said second Media Player software to play said received first desired content.

In system 10, server-computer 100 is a first server-playing device and comprises first embedded software and first Media Encoder software; said first embedded software causes said first Media Encoder software to select previously encoded first desired content already stored on said first server-playing device; and said first embedded software causes said first Media Encoder software to stream said first desired content to playing devices 401-404 being second server-playing devices; said second server-playing devices 401-404 comprising second embedded software and second Media Encoder software; said second embedded software causes said second Media Encoder software to select previously encoded second desired content already stored on said second server-playing devices 401-404; and said second embedded software causes said second Media Encoder software to stream said second desired content to said first server-playing device 100.

In system 10, Windows Media Encoder software and Windows Media Player software may be utilized.

In system 10, said feedback information may include the age of the playing device user.

In system 10, said feedback information may include the age of the server-computer user.

In system 10, said feedback information may include the location of the playing device.

In system 10, said feedback information may include the location of the server-computer.

In system 10, said feedback information may include the profession of the playing device user.

In system 10, said feedback information may include the profession of the server-computer user.

In system 10, said feedback information may include the employer of the playing device user.

In system 10, said feedback information may include the employer of the server-computer user.

In system 10, said feedback information may include the brand name of the playing device.

In system 10, said feedback information may include the brand name of the server-computer.

In system 10, said feedback information may include the birthplace of the playing device user.

In system 10, said feedback information may include the birthplace of the server-computer user.

In system 10, said feedback information may include the residence of the playing device user.

In system 10, said feedback information may include the residence of the server-computer user.

In system 10, said feedback information may include the marital status of the playing device user.

In system 10, said feedback information may include the marital status of the server-computer user.

In system 10, said feedback information may include the time when the playing device user commenced access to his desired content.

In system 10, said feedback information may include the time when the server-computer user commenced access to his desired content.

In system 10, said feedback information may include the time when the playing device user terminated access to his desired content.

In system 10, said feedback information may include the time when the server-computer user terminated access to his desired content.

In system 10, said feedback information may include the advertising content viewed by the playing device user.

In system 10, said feedback information may include the advertising content viewed by the server-computer user.

In system 10, said feedback information may include the advertising content not viewed by the playing device user.

In system 10, said feedback information may include the advertising content not viewed by the server-computer user.

In system 10, said feedback information may include any criteria relating to the playing device user.

In system 10, said feedback information may include any criteria relating to the server-computer user.

In system 10, the source device may be a video cassette recording device.

In system 10, the source device may be a digital video disc playing devices.

In system 10, the source device may be a television set.

In system 10, the source device may be a web cam device.

In system 10, the source devices may provide pre-recorded content.

In system 10, the source device may be a baby cam device.

In system 10, the source device may be a security camera device.

In system 10, the source device may be a USB format output camera device.

In system 10, the source device may be a sensing device.

In system 10, the source device may be a transducer device.

In system 10, the playing device may be a personal computing device.

In system 10, the playing device may be a cellular telephone device.

In system 10, the playing device may be a personal computing device.

In system 10, the playing device may be a personal digital assistant device.

In system 10, the playing device may be a laptop computer device.

In system 10, the playing device may be a broadband internet connected device.

In system 10, the playing device may be a local area network connected device.

In system 10, the playing device may be a wide area network connected device.

In system 10, the playing device may be a wireless connected device.

System 10 comprises: a tuning device; the source devices being responsive to said tuning device for selectively providing said first desired content to said tuning device, and said tuning device providing said first desired content to server-computer 100. Said source devices may be an antenna device, a cable box device, a digital video recording device, a TIVO device, a composite output camera device.

System 10 comprises: a remote control device, the source devices being responsive to said remote control device for selectively providing said first desired content to server-computer 100. Said source devices may be a cable box device, a digital video playing device, a digital video recording device, a TIVO device, Media broadcasting System 10 comprises Media Broadcasting Device 100 having first embedded software. Said Media Broadcasting Device receives a signal from audio/video source devices 101-107; said first embedded software causes said Media Broadcasting Device to construct a first media stream from such signal; and said Media Broadcasting Device transmits said first media stream over a network. Media Playing Devices 401-404 have second embedded software; said Media Playing Devices 401-404 communicate with said Media Broadcasting Device over the network; and said second embedded software causes said Media Playing Devices to receive and play said first media stream.

In system 10, the network may comprise the Internet, a wide area network, a local area network, a wireless network.

System 10 comprises: director server-computer 200 which allows said Media Broadcasting Device to provide said first media stream to said Media Playing Devices 401-404; and advertising server-computer 300 for receiving feedback information from said Media Broadcasting Device, from Director Server-computer 200, and from said Media Playing Devices 401-404; and Advertising server-computer 300 for providing advertising information to said Media Playing Devices 401-404 and to said Media Broadcasting Device in response to said feedback information.

While the present invention has been described in terms of specific illustrative embodiments, it will be apparent to those skilled in the art that many other embodiments and modifications are possible within the spirit and scope of the disclosed principle.

What is claimed is:

1) In a system being capable of allowing access to desired content over a network, said system comprising: a server-computer; a source device being capable of providing a first desired content to said server-computer; a playing device being capable of receiving said first desired content from said server-computer and being capable of playing said first desired content; a director server-computer being capable of allowing said server-computer to provide said first desired content to said playing device; and an advertising server-computer being capable of receiving feedback information: from said server-computer: from said director server-computer: and from said playing device; and said advertising server-computer being capable of providing advertising information to said playing device in response to said feedback information.

2) In the system of claim 1, said advertising server-computer being capable of providing advertising information to said server-computer in response to said feedback information.

3) In a system being capable of allowing access to desired content over a network, said system comprising: a server-computer; a source device being capable of providing a first desired content to said server-computer; a playing device being capable of receiving said first desired content from said server-computer and being capable of playing said first desired content; a director server-computer being capable of allowing said server-computer to provide said first desired content to said playing device; and an advertising server-computer being capable of receiving feedback information: from said server-computer: from said director server-computer: and from said playing device; and said advertising server-computer being capable of providing advertising information to said server-computer in response to said feedback information.

4) In a system being capable of allowing access to desired content over a network, said system comprising: a first server-playing device; a source device being capable of providing a first desired content to said first server-playing device; a second server-playing device being capable of receiving said first desired content from said first server-laying device and being capable of playing said first desired content; a director server-computer being capable of allowing said first server-playing device to provide said first desired content to said second server-playing device; and an advertising server-computer being capable of receiving feedback information from said first server-playing device, from said director server-computer, and from said second server-playing device; and said advertising server-computer being capable of providing advertising information to said second server-playing device in response to said feedback information.

5) In the system of claim 1, said advertising server-computer being capable of providing advertising information to said first server-playing device in response to said feedback information.

6) In a system being capable of allowing access to desired content over a network, said system comprising: a first server-playing device; a source device being capable of providing a first desired content to said first server-playing device; a second server-playing device being capable of receiving said first desired content from said first server-playing device and being capable of playing said first desired content; a director server-computer being capable of allowing said first server-playing device to provide said first desired content to said second server-playing device; and an advertising server-computer being capable of receiving feedback information from said first server-playing device, from said director server-computer, and from said second server-playing device; said advertising server-computer being capable of providing advertising information to said first server-playing device in response to said feedback information.

7) In the system of claim 1, said director server-computer comprising a database of authorized playing device users and of authorized content and being capable of allowing said authorized playing device users to access said authorized content.

8) In the system of claim 1, said director server-computer comprising a database of authorized server-computer users and of authorized content and being capable of allowing said authorized server-computer users to access said authorized content.

9) In the system of claim 1, said director server-computer comprising a database of un-authorized playing device users and of authorized content and being capable of blocking said un-authorized playing device users from accessing said authorized content.

10) In the system of claim 1, said director server-computer comprising a database of un-authorized server-computer users and of authorized content and being capable of blocking said un-authorized server-computer users from accessing said authorized content.

11) In the system of claim 1, said director server-computer comprising a database of authorized server-computer users and of un-authorized content and being capable of blocking said authorized server-computer users from accessing said un-authorized content.

12) In the system of claim 1, said director server-computer comprising a database of authorized playing device users and of un-authorized content and being capable of blocking said authorized playing device users from accessing said un-authorized content.

13) In the system of claim 1, said director server-computer comprising a database of authorized server-computer users and of un-authorized content and being capable of blocking said authorized server-computer users from accessing said un-authorized content.

14) In the system of claim 1, said director server-computer comprising a database of un-authorized playing device users and of un-authorized content and being capable of blocking said un-authorized playing device users from accessing said un-authorized content.

15) In the system of claim 1, said director server-computer comprising a database of un-authorized server-computer users and of un-authorized content and being capable of blocking said un-authorized server-computer users from accessing said un-authorized content.

16) In the system of claim 1, said network being the Internet.

17) In the system of claim 1, said server-computer comprising embedded software and Media Encoder software; said embedded software being capable of causing said Media Encoder software to select the correct software driver for capturing said first desired content from its respective source device; said embedded software being capable of causing said Media Encoder software to encode said first desired content; and said embedded software being capable of causing said Media Encoder software to stream said first desired content to the playing device that requested said first desired content.

18) In the system of claim 1, said server-computer comprising embedded software and Media Encoder software; said embedded software being capable of causing said Media Encoder software to select previously encoded first desired content already stored on said server-computer; and said embedded software being capable of causing said Media Encoder software to stream said first desired content to the playing device that requested said first desired content.

19) In the system of claim 1, said playing device comprising embedded software and Media Encoder software; said embedded software being capable of causing said Media Encoder software to select the correct software driver for capturing a second desired content from said playing device; said embedded software being capable of causing said Media Encoder software to encode said second desired content; and said embedded software being capable of causing said Media Encoder software to stream said second desired content to said server-computer.

20) In the system of claim 1, said playing device comprising embedded software and Media Encoder software; said embedded software being capable of causing said Media Encoder software to select previously encoded second desired content already stored on said playing device; and said embedded software being capable of causing said Media Encoder software to stream said second desired content to said server-computer.

21) In the system of claim 1, said server-computer comprising embedded software and Media Player software; said embedded software being capable of causing said Media Player software to play received second desired content.

22) In the system of claim 1, said playing device comprising embedded software and Media Player software; said embedded software being capable of causing said Media Player software to play said received first desired content.

23) In the system of claim 1, said server-computer comprising first embedded software and first Media Encoder software; said first embedded software being capable of causing said first Media Encoder software to select the correct software driver for capturing said first desired content from its respective source device; said first embedded software being capable of causing said first Media Encoder software to encode said first desired content; and said first embedded software being capable of causing said first Media Encoder software to stream said first desired content to the playing device that requested said first desired content; said playing device comprising second embedded software and second Media Encoder software; said second embedded software being capable of causing said second Media Encoder software to select the correct software driver for capturing a second desired content from said playing device; said second embedded software being capable of causing said second Media Encoder software to encode said second desired content; and said second embedded software being capable of causing said second Media Encoder software to stream said second desired content to said server-computer.

24) In the system of claim 1, said server-computer comprising first embedded software and first Media Player software; said first embedded software being capable of causing said first Media Player software to play received second desired content; said playing device comprising second embedded software and second Media Player software; said second embedded software being capable of causing said second Media Player software to play said received first desired content.

25) In the system of claim 1, said server-computer comprising first embedded software and first Media Encoder software; said first embedded software being capable of causing said first Media Encoder software to select previously encoded first desired content already stored on said server-computer; and said first embedded software being capable of causing first said Media Encoder software to stream said first desired content to the playing device that requested said first desired content; said playing device comprising second embedded software and second Media Encoder software; said second embedded software being capable of causing said second Media Encoder software to select previously encoded second desired content already stored on said playing device; and said second embedded software being capable of causing said second Media Encoder software to stream said second desired content to said server-computer.

26) In the system of claim 1, said server-computer being a first server-playing device and comprising embedded software and Media Encoder software; said embedded software being capable of causing said Media Encoder software to select the correct software driver for capturing said first desired content from its respective source device; said embedded software being capable of causing said Media Encoder software to encode said first desired content; and said embedded software being capable of causing said Media Encoder software to stream said first desired content to said playing device being a second server-playing device.

27) In the system of claim 1, said server-computer being a first server-playing device and comprising embedded software and Media Encoder software; said embedded software being capable of causing said Media Encoder software to select previously encoded first desired content already stored on said first server-playing device; and said embedded software being capable of causing said Media Encoder software to stream said first desired content to said playing device being a second server-playing device.

28) In the system of claim 1, said playing device being a second server-playing device and comprising embedded software and Media Encoder software; said embedded software being capable of causing said Media Encoder software to select the correct software driver for capturing a second desired content from said second server-playing device; said embedded software being capable of causing said Media Encoder software to encode said second desired content; and said embedded software being capable of causing said Media Encoder software to stream said second desired content to said server-computer being a first server-playing device.

29) In the system of claim 1, said playing device being a second server-playing device and comprising embedded software and Media Encoder software; said embedded software being capable of causing said Media Encoder software to select previously encoded second desired content already stored on said second server-playing device; and said embedded software being capable of causing said Media Encoder software to stream said second desired content to said server-computer being a first server-playing device.

30) In the system of claim 1, said server-computer being a first server-playing device and comprising embedded software and Media Player software; said embedded software being capable of causing said Media Player software to play a received second desired content.

31) In the system of claim 1, said playing device being a second server-playing device and comprising embedded software and Media Player software; said embedded software being capable of causing said Media Player software to play said received first desired content.

32) In the system of claim 1, said server-computer being a first server-playing device and comprising first embedded software and first Media Encoder software; said first embedded software being capable of causing said first Media Encoder software to select the correct software driver for capturing said first desired content from its respective source device; said first embedded software being capable of causing said first Media Encoder software to encode said first desired content; and said first embedded software being capable of causing said first Media Encoder software to stream said first desired content to said playing device being a second server-playing device; said second server-playing device comprising second embedded software and second Media Encoder software; said second embedded software being capable of causing said second Media Encoder software to select the correct software driver for capturing a second desired content from said second server-playing device; said second embedded software being capable of causing said second Media Encoder software to encode said second desired content; and said second embedded software being capable of causing said second Media Encoder software to stream said second desired content to said first server-playing device.

33) In the system of claim 1, said server-computer being a first server-playing device and comprising first embedded software and first Media Player software; said first embedded software being capable of causing said first Media Player software to play a received second desired content; said playing device being a second server-playing device and comprising second embedded software and second Media Player software; said second embedded software being capable of causing said second Media Player software to play said received first desired content.

34) In the system of claim 1, said server-computer being a first server-playing device and comprising first embedded software and first Media Encoder software; said first embedded software being capable of causing said first Media Encoder software to select previously encoded first desired content already stored on said first server-playing device; and said first embedded software being capable of causing said first Media Encoder software to stream said first desired content to the said playing device being a second server-playing device; said second server-playing device comprising second embedded software and second Media Encoder software; said second embedded software being capable of causing said second Media Encoder software to select previously encoded second desired content already stored on said second server-playing device; and said second embedded software being capable of causing said second Media Encoder software to stream said second desired content to said first server-playing device.

35) In the system of claim 1, said server-computer comprising embedded software and Windows Media Encoder software; said embedded software being capable of causing said Windows Media Encoder software to select the correct software driver for capturing said first desired content from its respective source device; said embedded software being capable of causing said Windows Media Encoder software to encode said first desired content; and said embedded software being capable of causing said Windows Media Encoder software to stream said first desired content to the playing device that requested said first desired content.

36) In the system of claim 1, said server-computer comprising embedded software and Windows Media Encoder software; said embedded software being capable of causing said Windows Media Encoder software to select previously encoded first desired content already stored on said server-computer; and said embedded software being capable of causing said Windows Media Encoder software to stream said first desired content to the playing device that requested said first desired content.

37) In the system of claim 1, said playing device comprising embedded software and Windows Media Encoder software; said embedded software being capable of causing said Windows Media Encoder software to select the correct software driver for capturing a second desired content from said playing device; said embedded software being capable of causing said Windows Media Encoder software to encode said second desired content; and said embedded software being capable of causing said Windows Media Encoder software to stream said second desired content to said server-computer.

38) In the system of claim 1, said playing device comprising embedded software and Windows Media Encoder software; said embedded software being capable of causing said Windows Media Encoder software to select previously encoded second desired content already stored on said playing device; and said embedded software being capable of causing said Windows Media Encoder software to stream said second desired content to said server-computer.

39) In the system of claim 1, said server-computer comprising embedded software and Windows Media Player software; said embedded software being capable of causing said Windows Media Player software to play received second desired content.

40) In the system of claim 1, said playing device comprising embedded software and Windows Media Player software; said embedded software being capable of causing said Windows Media Player software to play said received first desired content.

41) In the system of claim 1, said server-computer comprising first embedded software and first Windows Media Encoder software; said first embedded software being capable of causing said first Windows Media Encoder software to select the correct software driver for capturing said first desired content from its respective source device; said first embedded software being capable of causing said first Windows Media Encoder software to encode said first desired content; and said first embedded software being capable of causing said first Windows Media Encoder software to stream said first desired content to the playing device that requested said first desired content; said playing device comprising second embedded software and second Windows Media Encoder software; said second embedded software being capable of causing said second Windows Media Encoder software to select the correct software driver for capturing a second desired content from said playing device; said second embedded software being capable of causing said second Windows Media Encoder software to encode said second desired content; and said second embedded software being capable of causing said second Windows Media Encoder software to stream said second desired content to said server-computer.

42) In the system of claim 1, said server-computer comprising first embedded software and first Windows Media Player software; said first embedded software being capable of causing said first Windows Media Player software to play received second desired content; said playing device comprising second embedded software and second Windows Media Player software; said second embedded software being capable of causing said second Windows Media Player software to play said received first desired content.

43) In the system of claim 1, said server-computer comprising first embedded software and first Windows Media Encoder software; said first embedded software being capable of causing said first Windows Media Encoder software to select previously encoded first desired content already stored on said server-computer; and said first embedded software being capable of causing first said Windows Media Encoder software to stream said first desired content to the playing device that requested said first desired content; said playing device comprising second embedded software and second Windows Media Encoder software; said second embedded software being capable of causing said second Windows Media Encoder software to select previously encoded second desired content already stored on said playing device; and said second embedded software being capable of causing said second Windows Media Encoder software to stream said second desired content to said server-computer.

44) In the system of claim 1, said feedback information including the age of the playing device user.

45) In the system of claim 1, said feedback information including the age of the server-computer user.

46) In the system of claim 1, said feedback information including the location of the playing device.

47) In the system of claim 1, said feedback information including the location of the server-computer.

48) In the system of claim 1, said feedback information including the profession of the playing device user.

49) In the system of claim 1, said feedback information including the profession of the server-computer user.

50) In the system of claim 1, said feedback information including the employer of the playing device user.

51) In the system of claim 1, said feedback information including the employer of the server-computer user.

52) In the system of claim 1, said feedback information including the brand name of the playing device.

53) In the system of claim 1, said feedback information including the brand name of the server-computer.

54) In the system of claim 1, said feedback information including the birthplace of the playing device user.

55) In the system of claim 1, said feedback information including the birthplace of the server-computer user.

56) In the system of claim 1, said feedback information including the residence of the playing device user.

57) In the system of claim 1, said feedback information including the residence of the server-computer user.

58) In the system of claim 1, said feedback information including the marital status of the playing device user.

59) In the system of claim 1, said feedback information including the marital status of the server-computer user.

60) In the system of claim 1, said feedback information including the time when the playing device user commenced access to his desired content.

61) In the system of claim 1, said feedback information including the time when the server-computer user commenced access to his desired content.

62) In the system of claim 1, said feedback information including the time when the playing device user terminated access to his desired content.

63) In the system of claim 1, said feedback information including the time when the server-computer user terminated access to his desired content.

64) In the system of claim 1, said feedback information including the advertising content viewed by the playing device user.

65) In the system of claim 1, said feedback information including the advertising content viewed by the server-computer user.

66) In the system of claim 1, said feedback information including the advertising content not viewed by the playing device user.

67) In the system of claim 1, said feedback information including the advertising content not viewed by the server-computer user.

68) In the system of claim 1, said feedback information including any criteria relating to the playing device user.

69) In the system of claim 1, said feedback information including any criteria relating to the server-computer user.

70) In the system of claim 1, said source device being a video cassette recording device.

71) In the system of claim 1, said source device being a digital video disc playing device.

72) In the system of claim 1, said source device being a television set.

73) In the system of claim 1, said source device being a web cam device.

74) In the system of claim 1, said source device providing pre-recorded content.

75) In the system of claim 1, said source device being a baby cam device.

76) In the system of claim 1, said source device being a security camera device.

77) In the system of claim 1, said source device being a USB format output camera device.

78) In the system of claim 1, said source device being a sensing device.

79) In the system of claim 1, said source device being a transducer device.

80) In the system of claim 1, said playing device being a personal computing device.

81) In the system of claim 1, said playing device being a cellular telephone device.

82) In the system of claim 1, said playing device being a personal computing device.

83) In the system of claim 1, said playing device being a personal digital assistant device.

84) In the system of claim 1, said playing device being a laptop computer device.

85) In the system of claim 1, said playing device being a broadband internet connected device.

86) In the system of claim 1, said playing device being a local area network connected device.

87) In the system of claim 1, said playing device being a wide area network connected device.

88) In the system of claim 1, said playing device being a wireless connected device.

89) In the system of claim 1, said system comprising a tuning device, said source device being responsive to said tuning device for selectively providing said first desired content to said tuning device, and said tuning device providing said first desired content to said server-computer.

90) In the system of claim 89, said source device being an antenna device.

91) In the system of claim 89, said source device being a cable box device.

92) In the system of claim 89, said source device being a digital video recording device.

93) In the system of claim 89, said source device being a TIVO device.

94) In the system of claim 89, said source device being a composite output camera device.

95) In the system of claim 89, said source device being an antenna device.

96) In the system of claim 1, said system comprising a remote control device, said source device being responsive to said remote control device for selectively providing said first desired content to said server-computer.

97) In the system of claim 96, said source device being a cable box device.

98) In the system of claim 96, said source device being a digital video playing device.

99) In the system of claim 96, said source device being a digital video recording device.

100) In the system of claim 96, said source device being a TIVO device.

101) A media broadcasting system comprising: a Media Broadcasting Device having first embedded software; said Media Broadcasting Device being capable of receiving a signal from an audio/video source device; said first embedded software being capable of causing said Media Broadcasting Device to construct a first media stream from such signal; and said Media Broadcasting Device being capable of transmitting said first media stream over a network; and a Media Playing Device having second embedded software; said Media Playing Device being capable of communicating with said Media Broadcasting Device over the network; and said second embedded software being capable of causing said Media Playing Device to receive and play said first media stream.

102) In the system of claim 101, said Media Broadcasting Device comprising an interface being capable of receiving the signal from each of a plurality of types of audio/video source devices.

103) In the system of claim 101, said audio/visual source device being a television.

104) In the system of claim 101, said audio/visual source device being a video recorder.

105) In the system of claim 101, said audio/visual source device being a cable box.

106) In the system of claim 101, said audio/visual source device being a video camera.

107) In the system of claim 101, said network comprising the Internet.

108) In the system of claim 101, said network comprising a wide area network.

109) In the system of claim 101, said network comprising a local area network.

110) In the system of claim 101, said network comprising a wireless network.

111) In the system of claim 101, said Media Playing Device being a personal computer.

112) In the system of claim 101, said Media Playing Device being a cellular phone.

113) In the system of claim 101, said Media Playing Device being a personal digital assistant.

114) In the system of claim 101, said Media Broadcasting Device comprising Media Encoder Software, and said first embedded software being capable of causing said Media Encoder Software to provide said first media stream.

115) In the system of claim 101, said Media Playing Device comprising Media Player Software, and said second embedded software being capable of causing said Media Player Software to receive and play said first media stream.

116) In the system of claim 101, said Media Broadcasting Device comprising Media Player Software, and said first embedded software being capable of causing said Media Player Software to receive and process a second media stream from said Media Playing Device.

117) In the system of claim 101, said Media Playing Device comprising Media Encoder Software, and said second embedded software being capable of causing said Media Encoder Software to provide a second media stream to said Media Broadcasting Device.

118) In the system of claim 101, said Media Broadcasting Device comprising both Media Encoder Software and Media Player Software, said first embedded software being capable of causing said Media Encoder Software to provide said first media stream to said Media Playing Device and being capable of causing said Media Player Software to receive and process a second media stream from said Media Playing Device.

119) In the system of claim 101, said Media Playing Device comprising both Media Player Software and Media Encoder Software, said second embedded software being capable of causing said Media Encoder Software to provide a second media stream to said Media Broadcasting Device and being capable of causing said Media Player Software to receive and play said first media stream from said Media Broadcasting Device.

120) In the system of claim 101, said Media Broadcasting Device and said Media Playing Device both comprising Media Player Software and Media Encoder Software; said first embedded software being capable of causing said Media Encoder Software at said Media Broadcasting Device to provide said first media stream; said second embedded software being capable of causing said Media Encoder Software at said Media Playing Device to provide a second media stream; said second embedded software being capable of causing said Media Player Software at said Media Playing Device to receive and play said first media stream; and said first embedded software being capable of causing said Media Player Software at said Media Broadcasting Device to receive and play said second media stream.

121) In the system of claim 101, said Media Broadcasting Device comprising WINDOWS Media Encoder Software, and said first embedded software being capable of causing said WINDOWS Media Encoder Software to provide said first media stream.

122) In the system of claim 101, said Media Playing Device comprising WINDOWS Media Player Software, and said second embedded software being capable of causing said WINDOWS Media Player Software to receive and play said first media stream.

123) In the system of claim 101, said Media Broadcasting Device comprising WINDOWS Media Player Software, and said first embedded software being capable of causing said WINDOWS Media Player Software to receive and process a second media stream from said Media Playing Device.

124) In the system of claim 101, said Media Playing Device comprising WINDOWS Media Encoder Software, and said second embedded software being capable of causing said WINDOWS Media Encoder Software to provide a second media stream to said Media Broadcasting Device.

125) In the system of claim 101, said Media Broadcasting Device comprising both WINDOWS Media Encoder Software and WINDOWS Media Player Software, said first embedded software being capable of causing said WINDOWS Media Encoder Software to provide said first media stream to said Media Playing Device and being capable of causing said WINDOWS Media Player Software to receive and process a second media stream from said Media Playing Device.

126) In the system of claim 101, said Media Playing Device comprising both WINDOWS Media Player Software and WINDOWS Media Encoder Software, said second embedded software being capable of causing said WINDOWS Media Encoder Software to provide a second media stream to said Media Broadcasting Device and being capable of causing said WINDOWS Media Player Software to receive and play said first media stream from said Media Broadcasting Device.

127) In the system of claim 101, said Media Broadcasting Device and said Media Playing Device both comprising WINDOWS Media Player Software and WINDOWS Media Encoder Software; said first embedded software being capable of causing said WINDOWS Media Encoder Software at said Media Broadcasting Device to provide said first media stream; said second embedded software being capable of causing said WINDOWS Media Encoder Software at said Media Playing Device to provide a second media stream; said second embedded software being capable of causing said WINDOWS Media Player Software at said Media Playing Device to receive and play said first media stream; and said first embedded software being capable of causing said WINDOWS Media Player Software at said Media Broadcasting Device to receive and play said second media stream.

128) In the system of claim 101, said system comprising: a director server-computer being capable of allowing said Media Broadcasting Device to provide said first media stream to said Media Playing Device; and an advertising server-computer being capable of receiving feedback information from said Media Broadcasting Device, from said director server-computer, and from said Media Playing Device; and said advertising server-computer being capable of providing advertising information to said Media Playing Device in response to said feedback information.

129) In the system of claim 101, said system comprising: a director server-computer being capable of allowing said Media Broadcasting Device to provide said first media stream to said Media Playing Device; and an advertising server-computer being capable of receiving feedback information from said Media Broadcasting Device, from said director server-computer, and from said Media Playing Device; and said advertising server-computer being capable of providing advertising information to said Media Broadcasting Device in response to said feedback information.

130) In the system of claim 101, said director server-computer comprising a database of authorized Media Playing Device users and of authorized Media streams and being capable of allowing said authorized Media Playing Device users to access said authorized Media streams.

131) In the system of claim 101, said director server-computer comprising a database of un-authorized Media Playing Device users and of authorized Media streams and being capable of blocking said un-authorized Media Playing Device users from accessing said authorized Media streams.

132) In the system of claim 101, said director server-computer comprising a database of authorized Media Playing Device users and of un-authorized Media streams and being capable of blocking said authorized Media Playing Device users from accessing said un-authorized Media streams.

133) In the system of claim 101, said director server-computer comprising a database of un-authorized Media Playing Device users and of un-authorized Media streams and being capable of blocking said un-authorized Media Playing Device users from accessing said un-authorized Media streams.

134) In the system of claim 101, said feedback information including the age of said Media Playing Device user.

135) In the system of claim 101, said feedback information including the age of said Media Broadcasting Device user.

136) In the system of claim 101, said feedback information including the location of said Media Playing Device.

137) In the system of claim 101, said feedback information including the location of said Media Broadcasting Device.

138) In the system of claim 101, said feedback information including the profession of said Media Playing Device user.

139) In the system of claim 101, said feedback information including the profession of said Media Broadcasting Device user.

140) In the system of claim 101, said feedback information including the employer of said Media Playing Device user.

141) In the system of claim 101, said feedback information including the employer of Media Broadcasting Device user.

142) In the system of claim 101, said feedback information including the brand name of said Media Playing Device.

143) In the system of claim 101, said feedback information including the brand name of said Media Broadcasting Device.

144) In the system of claim 101, said feedback information including the birthplace of said Media Playing Device user.

145) In the system of claim 101, said feedback information including the birthplace of said Media Broadcasting Device user.

146) In the system of claim 101, said feedback information including the residence of said Media Playing Device user.

147) In the system of claim 101, said feedback information including the residence of said Media Broadcasting Device user.

148) In the system of claim 101, said feedback information including the marital status said Media Playing Device user.

149) In the system of claim 101, said feedback information including the marital status said Media Broadcasting Device user.

150) In the system of claim 101, said feedback information including any criteria relating to said Media Playing Device user.

151) In the system of claim 101, said feedback information including any criteria relating to said Media Broadcasting Device user.

152) In the system of claim 101, said feedback information including the time when said Media Broadcasting Device user commenced access to said first media stream.

153) In the system of claim 101, said feedback information including the time when said Media Playing Device user commenced access to said first media stream.

154) In the system of claim 101, said feedback information including the time when said Media Playing Device user terminated access to said first media stream.

155) In the system of claim 101, said feedback information including the time when said Media Broadcasting Device user terminated access to said first media stream.

156) In the system of claim 101, said feedback information including the advertising content viewed by said Media Playing Device user.

157) In the system of claim 101, said feedback information including the advertising content viewed by said Media Broadcasting Device user.

158) In the system of claim 101, said feedback information including the advertising content not viewed said Media Broadcasting Device user.

159) In the system of claim 101, said feedback information including the advertising content not viewed said Media Playing Device user.

160) In the system of claim 101, said audio/video source being a video cassette recording device.

161) In the system of claim 101, said audio/video source device being a digital video disc playing device.

162) In the system of claim 101, said audio/video source device being a television set.

163) In the system of claim 101, said audio/video source device being a web cam device.

164) In the system of claim 101, said audio/video source device providing pre-recorded content.

165) In the system of claim 101, said audio/video source device being a baby cam device.

166) In the system of claim 101, said audio/video source device being a security camera device.

167) In the system of claim 101, said audio/video source device being a USB format output camera device.

168) In the system of claim 101, said audio/video source device being a sensing device.

169) In the system of claim 101, said audio/video source device being a transducer device.

170) In the system of claim 101, said Media Playing Device being a personal computing device.

171) In the system of claim 101, said Media Playing Device being a cellular telephone device.

172) In the system of claim 101, said Media Playing Device being a personal computing device.

173) In the system of claim 101, said Media Playing Device being a personal digital assistant device.

174) In the system of claim 101, said Media Playing Device being a laptop computer device.

175) In the system of claim 101, said Media Playing Device being a broadband internet connected device.

176) In the system of claim 101, said Media Playing Device being a wade area network connected device.

177) In the system of claim 101, said Media Playing Device being a local area network connected device.

178) In the system of claim 101, said Media Playing Device being a wireless network connected device.

179) In the system of claim 101, said system comprising a tuning device, said audio/video source device being responsive to said tuning device for selectively providing said signal to said tuning device, and said tuning device providing said signal to said Media Broadcasting Device.

180) In the system of claim 179, said audio/video source device being an antenna device.

181) In the system of claim 179, said audio/video source device being a cable box device.

182) In the system of claim 179, said audio/video source device being a digital video recording device.

183) In the system of claim 179, said audio/video source device being a TIVO device.

184) In the system of claim 179, said audio/video source device being a composite output camera device.

185) In the system of claim 179, said audio/video source device being an antenna device.

186) In the system of claim 101, said system comprising a remote control device, said audio/video source device being responsive to said remote control device for selectively providing said signal to said Media Broadcasting Device.

187) In the system of claim 186, said audio/video source device being a cable box device.

188) In the system of claim 186, said audio/video source device being a digital video playing device.

189) In the system of claim 186, said audio/video source device being a digital video recording device.

190) In the system of claim 186, said audio/video source device being a TIVO device.

191) A method for allowing access to desired content over a network, said method comprising the steps of: providing a first desired content from a first source device to a first server-playing device; encoding said first desired content with said first server-playing device; allowing said encoded first desired content to be transmitted under the control of a director server-computer to a second server-playing device; receiving and decoding said encoded first desired content with said second server-playing device; playing said decoded first desired content with said second server-playing device; receiving feedback information with an advertising server-computer from said first server-playing device, said director server-computer, and said second server-playing device; and sending selected advertising information to said second server-playing device in response to said feedback information.

192) A method for allowing access to desired content over a network, said method comprising the steps of: providing a first desired content from a first source device to a first server-playing device; encoding said first desired content with said first server-playing device; allowing said encoded first desired content to be transmitted under the control of a director server-computer to a second server-playing device; receiving and decoding said encoded first desired content with said second server-playing device; playing said decoded first desired content with said second server-playing device; receiving feedback information with an advertising server-computer from said first server-playing device, said director server-computer, and said second server-playing device; and sending selected advertising information to said first server-playing device in response to said feedback information.

193) A method for allowing access to desired contents over a network, said method comprising the steps of: providing a first desired content from a first source device to a first server-playing device; encoding said first desired content with said first server-playing device; allowing said encoded first desired content to be transmitted under the control of a director server-computer to a second server-playing device; receiving and decoding said encoded first desired content with said second server-playing device; playing said decoded first desired content with said second server-playing device; providing a second desired content from a second source device to said second server-playing device; encoding said second desired content with said second server-playing device; allowing said encoded second desired content to be transmitted under the control of said director server-computer to said first server-playing device; receiving and decoding said encoded second desired content with said first server-playing device; playing said decoded second desired content with said first server-playing device; receiving feedback information with an advertising server-computer from said first server-playing device, said director server-computer, and said second server-playing device; and sending selected advertising information to said first server-playing device, or said second server-playing device, or both said first server-playing device and said second server-playing device in response to said feedback information.

194) In the method of claim 191, offering said desired content at no cost to the server-playing device user and charging a usage fee to the advertiser for providing said advertising information to said serving-playing device.

195) In the method of claim 192 offering said desired content at no cost to the server-playing device user and charging a usage fee to the advertiser for providing said advertising information to said serving-playing device.

196) In the method of claim 193, offering said desired contents at no cost to the server-playing device users and charging a usage fee to the advertiser for providing said advertising information to said serving-playing devices.

197) In the method of claim 191, storing in said director server-computer a database of authorized server-playing device users and of authorized content and allowing said authorized server-playing device users to access said authorized content.

198) In the method of claim 191, storing in said director server-computer a database of un-authorized server-playing device users and of authorized content and blocking said un-authorized server-playing device users from accessing said authorized content.

199) In the method of claim 191, storing in said director server-computer a database of authorized server-playing device users and of un-authorized content and blocking said authorized server-playing device users from accessing said un-authorized content.

200) In the method of claim 191, storing in said director server-computer a database of un-authorized server-playing device users and of un-authorized content and blocking said un-authorized server-playing device users from accessing said un-authorized content.

201) In the method of claim 191, said first source device responding to a tuning device for selectively providing said first desired content to said tuning device, and said tuning device providing said first desired content to said first server-playing device.

202) In the method of claim 191, said first source device responding to a remote control device for selectively providing said first desired content to said first server-playing device.
